(19) United States
(12) Patent Application Publication
(10) Pub. No.: US 2010/0253850 A1
(43) Pub. Date: Oct. 7, 2010

(54) VIDEO PRESENTATION SYSTEM

(75) Inventors: Daniel Stephen Cooper, Prairie Village, KS (US); Kenneth Carlton Cooper, Chesterfield, MO (US); Paul Martin Russell, Olathe, KS (US); Michael Wayne Imhoff, Nevada, TX (US); John Joseph Lawless, Austin, TX (US); Alexandru Mihail Itu, Zarnesti City (RO); Them Dac Ninh, Ha Noi City (VN)

Correspondence Address: Hovey Williams LLP, 10801 Mastin Blvd., Suite 1000, Overland Park, KS, 66210, US

(73) Assignee: EJ4, LLC, Overland Park, KS (US)

(21) Appl. No.: 12/417,775

(22) Filed: Apr. 3, 2009

(51) Int. Cl. H04N 9/74

(52) U.S. Cl. 348/587; 348/E09.055

(57) ABSTRACT

A video presentation system including a single physical computing device, a video capture device in communication with the physical computing device; and a computer readable medium readable by the physical computing device and including a video capture code segment for reading a video signal comprising a first plurality of pixels from the video capture device and storing the first set of pixels a buffer, an desktop capture code segment for capturing a content of a desktop of physical computing device and storing the content of the desktop in a buffer, and a chroma key code segment for setting a color value for a pixel in a buffer equal based on the color information of another pixel in another buffer.

### COMPUTER PROGRAM LISTING APPENDIX

A computer program listing appendix containing the source code of a computer program that may be used with the present invention is incorporated herein by reference and appended hereto, containing a total of one (1) file as follows:

| Date of Creation | Size (bytes) | Filename |
|---|---|---|
| 4/2/2009 | 573,829 | 40146_program_listing.txt |

The computer listings and other content contained in the foregoing are incorporated into the present application in their entirety by reference.

### BACKGROUND

The present invention relates to video presentation systems. More particularly, the invention relates to a video presentation system that executes on a single computing device and allows a user to demonstrate an application program displayed on the desktop of their computing device and simultaneously superimpose a chroma-keyed video source over the application and then save the result as a digital movie in real-time.

Video production systems were once reserved only for movie and television studios. Their cost was high and they required numerous computers or specialized electronic devices to function. As the power of computing devices has increased over time, video production has slowly become less expensive.

Chroma keying is a video effect included in some video production systems to superimpose a video feed over a background. To produce a chroma keyed effect, one color of the video feed is chosen as transparent and the video feed is superimposed over the background. However, to prevent the background from being completely obscured, areas from the video feed that are the transparent color are not displayed. For example, if green is chosen as the transparent color, and a video of a person standing in front of a green wall or screen is provided as the video feed, the person would appear to be standing in front of the chosen background because the green wall becomes transparent. This is the technique used by weathermen on television so that they appear to stand in front of a computer-generated weather map.

Presently, some video production can be performed on commonly available computing devices with special software or hardware. For example, non-linear editing systems for consumer computing devices allow for professional-quality video editing on consumer-level computing devices. Even after editing, these systems require significant time to process the source movies, generate effects and combine sources before a final movie is created. These systems also generally require dedicated computing devices to perform the editing along with separate cameras or video sources. They are also generally difficult to learn and relatively expensive.

Additionally, there are consumer video capture applications available. These video capture applications are typically included with low cost digital cameras or “web cams”, which are readily available. While they capture video and allow the video to be saved or uploaded to video-sharing web sites, they provide very limited editing capability and do not allow multiple video sources to be mixed.

Also, there are applications that allow for capture of interactions between a user and various application programs running on a computing device. These capture mouse movements and clicks and the resulting changes that occur as a result, but they do not capture video from an external video feed. These are useful to demonstrate features of an application program or educate other users how to use the application. Unfortunately, these programs are limited because they generally only display the application program or the desktop of the computing device. If a user wants to demonstrate a feature of an application program, this approach can be of limited efficacy.

If a user wants to create a demonstration of application programs on a computing device combined with video of a presenter, current solutions require multiple computing devices. A first computing device must run the application program to be demonstrated while a second computing device captures video of the presenter and combines the video with the desktop of the first computing device. While this solution is acceptable for some applications, for example in professional video production, consumers generally do not use multiple computing devices largely because of the expense and additional complexity involved.

Accordingly, there is a need for an improved video presentation system that overcomes these and other limitations.

### SUMMARY

The present invention solves the above-described problems and provides a distinct advance in the art of video presentation systems. More particularly, the present invention provides a video presentation system that allows for a video to be overlaid on top of the desktop of a computing device using chroma keying technology, and also allows interaction between the presenter and the application programs running on the computing device, but while only requiring a single computing device. The video presentation system also allows a movie to be created in real-time and saved to a computer-readable medium.

One embodiment of the video presentation system of the present invention broadly includes a physical computing device, a video capture device, and a computer readable medium.

The physical computing device is an electronic digital processor in communication with electronic memory, a video capture device, a computer-readable medium, and coupled with various optional electronic subsystems and electromechanical input devices, such as computer mice, keyboards, and the like. The video capture device includes various devices that capture digital video and are capable of providing the video signal to the physical computing device. The computer-readable medium is encoded with various code segments for performing the invention.

A video signal from the video capture device is captured and converted from a raw video stream into a series of discrete frames. The current state of the desktop of the computing device is also captured and stored.

The system then examines the color information of the individual pixels to determine whether particular pixels should be transparent or opaque. In one embodiment, pixels from the video capture device possessing a generally green color are identified and replaced with corresponding pixels from the current state of the desktop. In another embodiment, pixels generally matching reference pixels are identified and replaced with corresponding pixels from the current state of the desktop.

The resulting images are displayed on the physical display device as a digital video. Additionally, the resulting images are compressed and encoded as a digital video file and stored on a computer-readable medium for later use.

In use, this system provides an effective video presentation system that requires minimal physical computing devices. In one embodiment, the computing device includes a physical display device, a computer-readable medium, and two electromechanical input devices—a computer mouse and a electronic keyboard. Additionally, a commonly available video camera is attached to the physical computing device by way of a USB port.

This summary is provided to introduce a selection of concepts in a simplified form that are further described below in the detailed description below. This summary is not intended to identify key features or essential features of the claimed subject matter, nor is it intended to be used to limit the scope of the claimed subject matter. Other aspects and advantages of the present invention will be apparent from the following detailed description of the embodiments and the accompanying drawing figures.

### BRIEF DESCRIPTION OF THE DRAWING FIGURES

Embodiments of the present invention are described in detail below with reference to the attached drawing figures, wherein:

FIG. 1 is a schematic diagram illustrating components of a computer system that may be used to implement embodiments of the invention.

FIG. 2 is a schematic diagram illustrating the aggregation of the video stream and the desktop of the computing device in accordance with embodiments of the invention.

FIG. 3 is a schematic diagram illustrating the aggregation of the video stream and the desktop of the computing device in accordance with embodiments of the invention.

FIG. 4 is a flowchart illustrating the relationship of the code segments in accordance with embodiments of the invention.

The drawing figures do not limit the present invention to the specific embodiments disclosed and described herein. The drawings are not necessarily to scale, emphasis instead being placed upon clearly illustrating the principles of the invention.

### DETAILED DESCRIPTION

The following detailed description of the invention references the accompanying drawings that illustrate specific embodiments in which the invention can be practiced. The embodiments are intended to describe aspects of the invention in sufficient detail to enable those skilled in the art to practice the invention. Other embodiments can be utilized and changes can be made without departing from the scope of the present invention. The following detailed description is, therefore, not to be taken in a limiting sense. The scope of the present invention is defined only by the appended claims, along with the full scope of equivalents to which such claims are entitled.

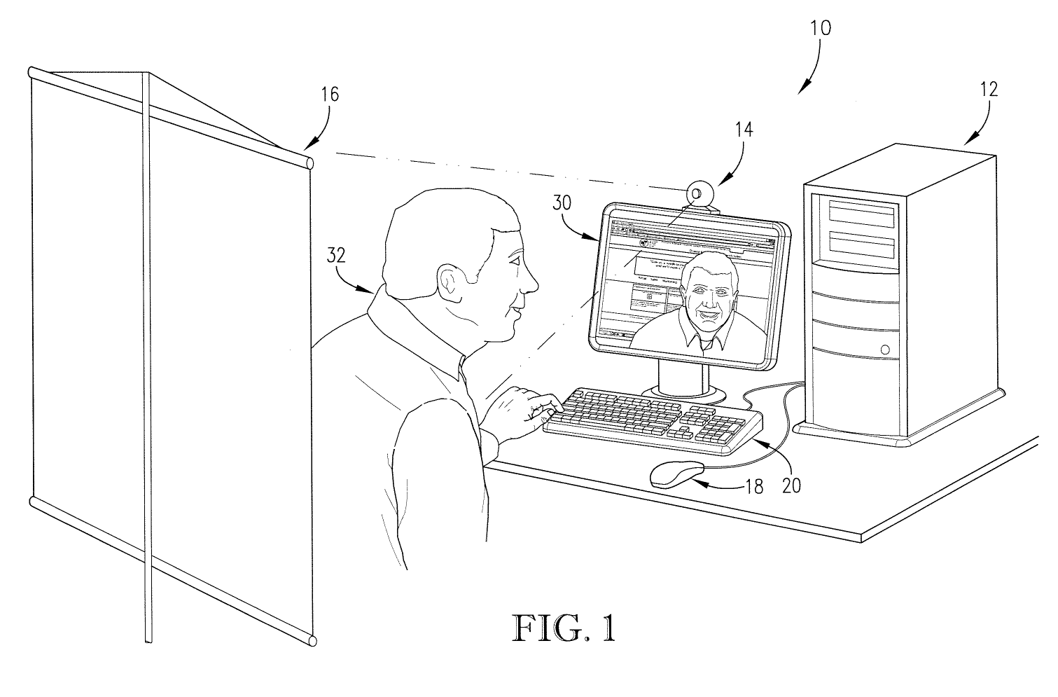

Turning now to the drawing figures, and particularly FIG. 1, a video presentation system constructed in accordance with an embodiment of the invention is illustrated. One embodiment of the video presentation system 10 of the present invention broadly includes a physical computing device 12, a video capture device 14, and a computer readable medium.

The physical computing device 12 is an electronic digital processor, or other similar devices, in communication with electronic memory, and coupled with various optional electronic subsystems and electromechanical input devices. The electronic digital processor is an integrated circuit or similar device and may be capable of executing a single instruction or it may have various circuits capable of processing several instructions simultaneously. The memory of the physical computing device 12 is an integrated circuit or similar device that allows data to be stored and retrieved. The memory may include various types of Random Access Memory (RAM), Read Only Memory (ROM), flash memory, and the like. The various optional electronic subsystems include various integrated circuits designed to aid the physical computing device 12 in some meaningful way. The electronic subsystems may include electronic graphics processing circuits, electronic sound processing circuits, network communication circuits, or the like. For example, a graphics processing subsystem may be connected to a physical display device 30. The electromechanical input devices include a variety of devices that convert mechanical action into digital signals understood by the physical computing device 12 described above. The electromechanical input devices include computer mice 18, electronic keyboards 20, trackballs, touch screens, and various other methods for converting movement into digital signals.

The video capture device 14 includes various devices that directly or indirectly convert visible light into a representation corresponding to one or more two-dimensional matrices of values corresponding to the light intensity in a particular frequency range at a particular location at multiple times per second. For example, a video camera attached to a physical computing device 12 is capable of converting visible light in the red, green and blue frequency ranges into digital movies. Additionally, an integrated circuit attached to the physical computing device 12 may be capable of indirectly converting a movie prerecorded in an analog format into a digital movie. The video capture device 14 can also be a web camera attached via one of the various revisions of the Universal Serial Bus (“USB”) or IEEE 1394 (“FireWire”) or it may be a different device attached through a dedicated integrated circuit directly attached to the physical computing device 12. In one embodiment, the video capture device 14 is oriented such that the complete field of view of the video capture device 14 contains only the user 32 and a green screen 16.

In the context of this application, a “computer-readable medium” can be any means that can contain, or store the program for use by or in connection with the electronic digital processor system, apparatus, or device. The computer-readable medium can be, for example, but not limited to, an electronic, magnetic, optical, electromagnetic, or semi-conductor system, apparatus, or device. More specific, although not inclusive, examples of the computer-readable medium would include the following: a portable computer diskette, a hard drive, a random access memory (RAM), a read-only memory (ROM), an erasable, programmable, read-only memory (EPROM or Flash memory), a DVD read-only memory (DVD-ROM), and a portable compact disk read-only memory (CDROM).

The computer-readable medium is encoded with various instructions for instructing the electronic digital processor to perform various atomic calculations, evaluations or commands. In the context of the present invention, the computer-readable medium includes numerous code segments for performing various aspects of the present invention. The computer-readable medium includes a video capture code segment, an desktop capture code segment, a chroma key code segment, and optionally, a scaling code segment, a display code segment, a compression code segment, and a storage code segment. The various code segments each implement specific functionality for the invention.

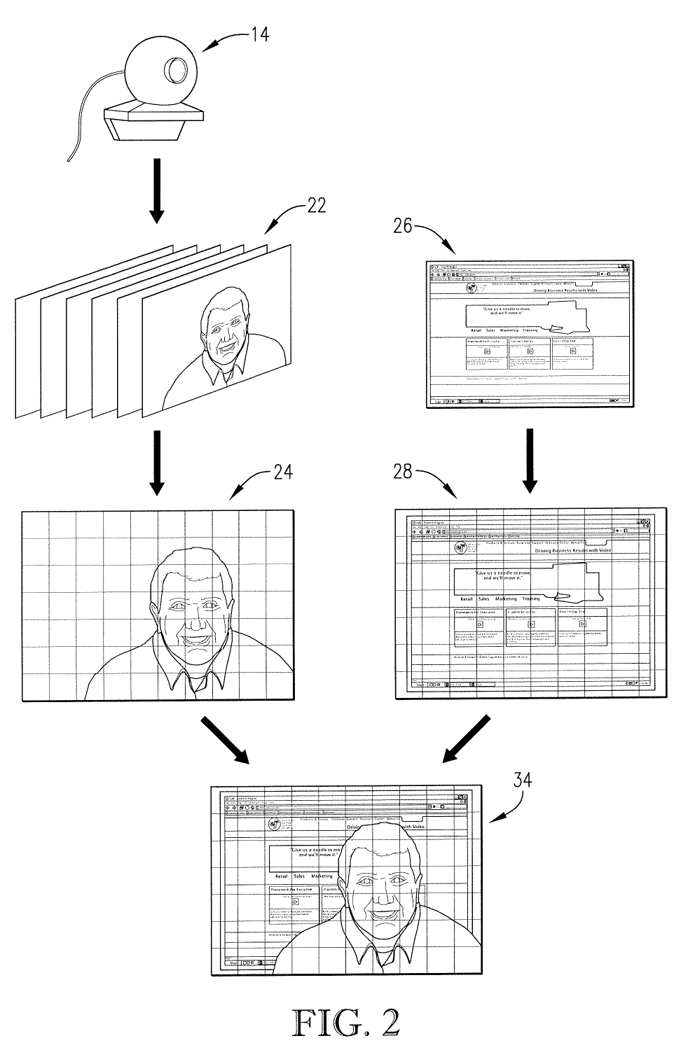

FIG. 2 shows the relationship of the data in one embodiment of the invention. Similarly, FIG. 4 shows the relationship of the code segments in one embodiment of the invention. These two figures are discussed together because the code and the data manipulated are necessarily interrelated.

The video capture segment 48 reads the video signal from the video capture device 14 and converts the video signal from a raw video stream into a series of discrete frames 22. The discrete frames 22 are sequentially stored into a first buffer 24 where they can be further examined and modified as necessary by other code segments.

The desktop capture code segment 36 captures the current state of the desktop of the computing device 26 and stores the contents into a second buffer 28. The desktop capture code segment 36 captures, among other things, the positions and contents of windows, the position and appearance of icons, and the position of appearance of the mouse cursor.

As is well known in the art, the color of a pixel can be represented in various color spaces. Colors are commonly represented as red, green, and blue components because computer monitors commonly display color using red, blue and green elements. Various other color representation mechanisms can be used, as well. Colors can be represented as a combination of the hue, saturation and brightness (HSB); hue, saturation and lightness (HSL); hue, saturation, and value (HSV); luminance and chrominance (YUV/Y′UV/YCbCr/YPbPr); or various other color spaces, as are well-known in the art. HSB and HSL representations are functionally equivalent. An additional alpha channel may also be used to represent the transparency of each pixel. Each color component may be represented by the physical computing device as integers or floating point values. The range of a single component may be between 0.0 and 1,0, between 0 and 255, or any other range as a matter of design choice and hardware capability. In HSB, HSL, and HSV representations, the range of the Hue component is typically, but not required to be, expressed in degrees and thus is commonly a number between 0 and 360, inclusive. The saturation, brightness, lightness, and value components may be between 0.0 and 1,0, between 0 and 255, or any other range as a matter of design choice and hardware capability. Similarly, the individual components of luminance-and-chrominance-represented pixels may be between 0.0 and 1,0, between 0 and 255, or any other range as a matter of design choice and hardware capability.

The chroma key code segment 38 examines the color information of the individual pixels to determine whether a particular pixel should be transparent or opaque. Various functional mappings based on the color information may be used to determine when a pixel is transparent. In one embodiment, the chroma key code segment 38 determines if the green component of a pixel is greater than a predefined threshold and if the green component of the pixel is greater than the red component of the pixel by a second predefined threshold and if the green component of the pixel is greater than the blue component of the pixel by a third predefined threshold. If each condition is true, then the pixel in the third buffer 34 will be set to the value of a corresponding pixel from the second buffer 28, or a equivalent interpolation or sampling from the second buffer 28, as necessary. Otherwise, the pixel in the third buffer 34 will be set to the value of a corresponding pixel from the first buffer 24. This embodiment may also be adapted employ blue as the transparent color by switching blue and green in the above example, or to red as the transparent color by switching red and green in the above example.

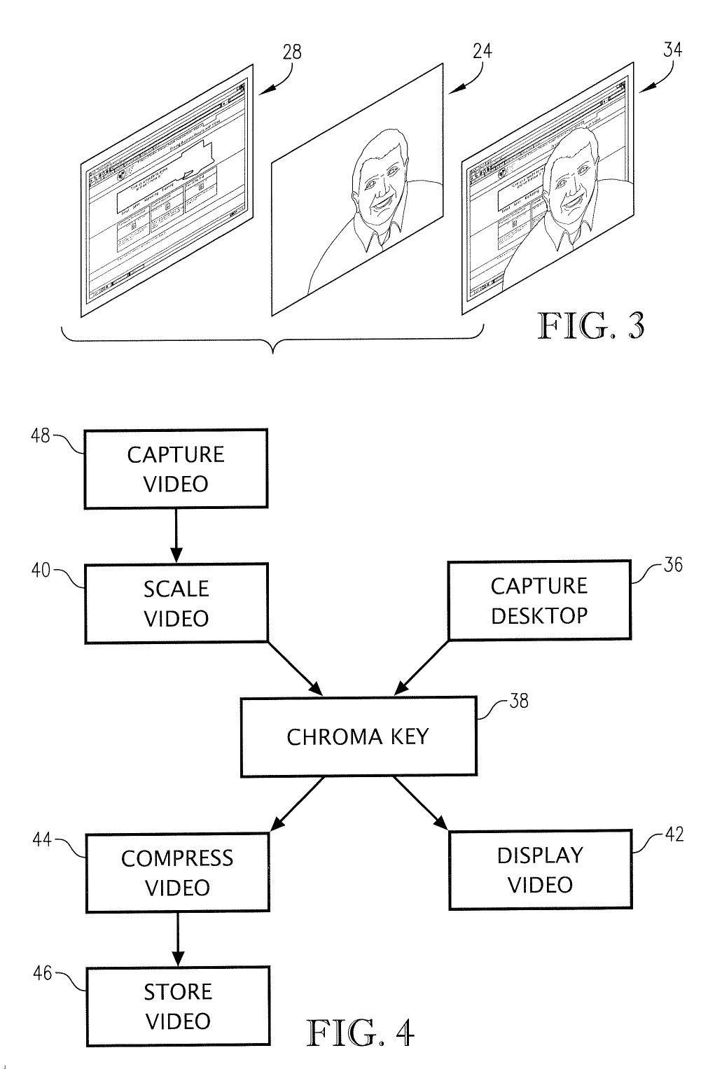

FIG. 3 shows this chroma keying process conceptually. The first buffer 24 contains the video captured by the video capture device 14 and all the green pixels in the first buffer 24 are transparent. The second buffer 28 contains the current state of the desktop of the physical computing device 14. No pixels in the second buffer 28 are transparent. The third buffer 34 contains the stacked combination of the first buffer 24 and the second buffer 28 with the non-green portions of the first buffer 24 superimposed over the contents of the second buffer 28.

In another embodiment, the chroma key code segment 38 determines if each of values of the hue, saturation and brightness components of a pixel are each within two thresholds of the corresponding color component of a corresponding pixel from a reference buffer. The two thresholds define an allowable range for each color component. For example, if the two thresholds define ranges such as [110, 130], [200, 255], [100, 120] for hue, saturation, and brightness, respectively, a pixel from the first buffer 24 will be transparent if the values of the color components of the pixel from the first buffer 24 are within the specified ranges. If the pixel from the first buffer 24 is transparent, the pixel in the third buffer 34 will be set to the value of a corresponding pixel from the second buffer 28. Otherwise, the pixel in the third buffer 34 will be set to the value of a corresponding pixel from the first buffer 24.

The optional code segments also implement specific functionality. The scaling code segment 40 resizes the first buffer 24 so that the dimensions of the first buffer 24 correspond to the dimensions of the second buffer 28. For example, the frames of a video stream 22 may be 640 pixels horizontally by 480 pixels vertically, but a computer desktop 26 may be 1024 pixels horizontally by 768 pixels vertically. In this case, the scaling code segment 40 will stretch the horizontal axis of the frames of the video stream 22 from 640 pixels to 1024 pixels, and the vertical axis from 480 pixels to 768 pixels. Various algorithms may be used to scale the image including nearest neighbor, linear interpolation, and polynomial interpolation.

The display code segment 42 reads the third buffer 34 produced by the chroma key code 38 segment an displays the third buffer 34 on a physical display device 30 of the physical computing device 12, possibly in conjunction with one of the various optional electronic subsystems, such as a electronic graphics processing circuit, if present. The physical display device 30 may constitute a computer monitor or other device operable to display video.

The compression code segment 44 reads the third buffer 34 produced by the chroma key code segment 38 and compresses and encodes the rendered content into one of the commonly known formats for digital video, such as one of the various Moving Picture Experts Group (MPEG) formats, Windows Media Video (WMV), or the like.

The storage code segment 46 reads the third buffer 34 produced by the chroma key code segment, or compressed content from the compression code segment 44, and stores the content to a computer-readable medium.

Turning again to FIG. 1, in use, the system of the present invention provides an effective video presentation system that requires only one physical computing device. In one embodiment, the computing device 12 includes a physical display device 30, a computer-readable medium, and two electromechanical input devices—a computer mouse 18 and a electronic keyboard 20. Additionally, a commonly available video camera 14 is attached to the physical computing device 12 by way of a USB port.

A green sheet, green screen 16, or other green-colored object is hung on a wall such that the field of view of the video camera 14 is bounded within the area covered by the green screen 16. A user 32 sits in between the video camera 14 and the green screen 16 so that the user is easily visible by the video camera 14 in front of the green background. Additionally the user 32 is positioned such that the computer mouse 18 and electronic keyboard 20 are easily accessible and the physical display device 30 can be seen. The user 32 executes a first computer program that, in turn, is caused to execute the video capture code segment 48, the chroma key code segment 38, the desktop capture code segment 36, the scaling code segment 40, the display code segment 42, the compression code segment 44, and the storage code segment 46. One or more of these code segments are executed repeatedly at numerous times per second. The user 32 then, for example, causes the computing device 12 to execute a second application program and performs a demonstration. The user 32 then interacts with the first computer program, causing the above code segments to complete their processing and stop. On the computer-readable medium is stored a compressed representation of the demonstration performed.

For example, a salesperson may create a presentation with commonly available presentation software and then superimpose his or her image over the presentation in order to distribute a digital video of the presentation to customers in geographically diverse areas or in order to allow the same presentation to be used repeatedly. Even if a salesman speaks to customers in person this solution is also advantageous because it avoids problems that commonly occur during live demonstrations, such as connectivity issues, that can detrimentally affect the impression of a potential client.

In another example, computer help-desk personnel may create videos demonstrating solutions for common problems experienced within the organization. This would allow for increased efficiency for the organization because it allows help-desk personnel to concentrate on more challenging issues while allowing users a personalized self-service option for support.

In a further example, a job applicant may create a customized video for a potential employer explaining their education, job history and relevant skills. This can provide an extremely customized solution that also maximizes the efficiency by streamlining much of redundant aspects of the interview process.

Although the invention has been described with reference to the preferred embodiment illustrated in the attached drawing figures, it is noted that equivalents may be employed and substitutions made herein without departing from the scope of the invention as recited in the claims.

Having thus described the preferred embodiment of the invention, what is claimed as new and desired to be protected by Letters Patent includes the following:

1. A video presentation system comprising:
a single physical computing device;
a video capture device in communication with the physical computing device; and
a computer readable medium readable by the physical computing device and comprising:
a video capture code segment stored on the physical computer readable medium for reading a video signal comprising a first plurality of pixels from the video capture device and storing the first plurality of pixels of the video signal in a first buffer;
an desktop capture code segment stored on the physical computer readable medium for capturing a content of a desktop of physical computing device and storing the content of the desktop in a second buffer comprising a second plurality of pixels; and
a chroma key code segment for setting a color value for a third pixel in a third buffer equal to the color value of a first pixel from the first plurality pixels or the color value of a second pixel from the second plurality of pixels based on the color information of the first pixel.

2. The video presentation system of claim 1, further comprising:
a physical display system in communication with the physical computing device; and
a display code segment stored on the physical computer readable medium for displaying the first buffer on the physical display system.

3. The video presentation system of claim 1, further comprising:
a compression code segment stored on the physical computer readable medium for compressing the first buffer into a video stream.

4. The video presentation system of claim 1, further comprising:
a storage code segment stored on the physical computer readable medium for storing the video stream on a physical computer readable medium.

5. The video presentation system of claim 1, wherein:
the color value of the first pixel additionally comprises red, green and blue components; and
the chroma key code sets the color value of the third pixel equal to the color value of the second pixel when:
the green component of the first pixel is greater than a first predefined threshold, and
the difference between the green component of the first pixel and the red component of the first pixel is greater than a second predefined threshold, and
the difference between the green component of the first pixel and the blue component of the first pixel is greater than a third predefined threshold; and
otherwise the chroma key code segment sets the color value of the third pixel equal to the color value of the first pixel.

6. The video presentation system of claim 1, wherein:
the color value of the first pixel additionally comprises hue, saturation and brightness components;
the chroma key code segment sets the color value of the third pixel equal to the color value of the second pixel when:
the hue component of the first pixel is greater than or equal to a first predefined threshold and the hue component of the first pixel is less than or equal to a second predefined threshold, and
the saturation component of the first pixel is greater than or equal to a third predefined threshold and the saturation component of the first pixel is less than or equal to a fourth predefined threshold, and
the brightness component of the first pixel is greater than or equal to a fifth predefined threshold and the brightness component of the first pixel is less than or equal to a sixth predefined threshold; and
otherwise the chroma key code segment sets the color value of the third pixel equal to the color value of the first pixel.

7. The video presentation system of claim 1, wherein the first buffer has a first dimension and a second dimension and the second buffer has a first dimension and a second dimension, further comprising:
a scaling code segment for resizing the first buffer such that the first dimension of the first buffer is equal to the first dimension of the second buffer and the second dimension of the first buffer is equal to the second dimension of the second buffer.

8. The video presentation system of claim 1, wherein the video capture device communicates with the physical computing device through an interface chosen from the group consisting of Universal Serial Bus, or Firewire.

9. The video presentation system of claim 2, wherein the physical display system is a computer monitor.

10. A video presentation system comprising:
a physical computing device;
a video capture device in communication with the physical computing device;
a physical display system in communication with the physical computing device; and
a computer readable medium readable by the physical computing device and comprising:
a video capture code segment stored on the physical computer readable medium for reading a video signal comprising a first plurality of pixels from the video capture device and storing the first plurality of pixels of the video signal in a first buffer, the first buffer having a first dimension and a second dimension;
an desktop capture code segment stored on the physical computer readable medium for capturing a content of a desktop of physical computing device and storing the content of the desktop in a second buffer comprising a second plurality of pixels, the second buffer having a first dimension and a second dimension;
a scaling code segment for resizing the first buffer such that the first dimension of the first buffer is equal to the first dimension of the second buffer and the second dimension of the first buffer is equal to the second dimension of the second buffer;
a chroma key code segment for setting a color value for a third pixel in a third buffer equal to the color value of a first pixel from the first plurality pixels or the color value of a second pixel from the second plurality of pixels based on the color information of the first pixel.
a display code segment stored on the physical computer readable medium for displaying the video stream on the physical display system;
a compression code segment stored on the physical computer readable medium for compressing the video stream; and
a storage code segment stored on the physical computer readable medium for storing the video stream on a physical computer readable medium.

11. The video presentation system of claim 10, wherein:
the color value of first pixel additionally comprises red, green and blue components; and
the chroma key code segment sets the color value of the third pixel equal to the color value of the second pixel when:
the green component of the first pixel is greater than a first predefined threshold, and
the difference between the green component of the first pixel and the red component of the first pixel is greater than a second predefined threshold, and
the difference between the green component of the first pixel and the blue component of the first pixel is greater than a third predefined threshold; and
otherwise the chroma key code segment sets the color value of the third pixel equal to the color value of the first pixel.

12. The video presentation system of claim 10, wherein:
the color value of the first pixel additionally comprises hue, saturation and brightness components;
the chroma key code segment sets the color value of the third pixel equal to the color value of the second pixel when:
the hue component of the first pixel is greater than or equal to a first predefined threshold and the hue component of the first pixel is less than or equal to a second predefined threshold, and
the saturation component of the first pixel is greater than or equal to a third predefined threshold and the saturation component of the first pixel is less than or equal to a fourth predefined threshold, and
the brightness component of the first pixel is greater than or equal to a fifth predefined threshold and the brightness component of the first pixel is less than or equal to a sixth predefined threshold; and
otherwise the chroma key code segment sets the color value of the third pixel equal to the color value of the first pixel.

13. The video presentation system of claim 10, wherein the video capture device communicates with the physical computing device through an interface chosen from the group consisting of Universal Serial Bus, or Firewire.

14. A computer readable medium operable to be read by a physical computing device and comprising:
a video capture code segment stored on the physical computer readable medium for reading a video signal comprising a first plurality of pixels and storing the first plurality of pixels of the video signal in a first buffer;
an desktop capture code segment stored on the physical computer readable medium for capturing a content of a desktop of the physical computing device and storing the content of the desktop in a second buffer comprising a second plurality of pixels;
a chroma key code segment for setting a color value for a third pixel in a third buffer equal to the color value of a first pixel from the first plurality pixels or the color value of a second pixel from the second plurality of pixels based on the color information of the first pixel.

15. The computer readable medium of claim 14, further comprising:
a display code segment stored on the physical computer readable medium for displaying the video stream on a physical display system.

16. The computer readable medium of claim 14, further comprising:
a compression code segment stored on the physical computer readable medium for compressing the video stream.

17. The computer readable medium of claim 14, further comprising:
a storage code segment stored on the physical computer readable medium for storing the video stream on a physical computer readable medium.

18. The video presentation system of claim 14, wherein:
the color value of first pixel additionally comprises red, green and blue components; and
the chroma key code segment sets the color value of the third pixel equal to the color value of the second pixel when:
the green component of the first pixel is greater than a first predefined threshold, and
the difference between the green component of the first pixel and the red component of the first pixel is greater than a second predefined threshold, and
the difference between the green component of the first pixel and the blue component of the first pixel is greater than a third predefined threshold; and
otherwise the chroma key code segment sets the color value of the third pixel equal to the color value of the first pixel.

19. The video presentation system of claim 14, wherein:
the color value of the first pixel additionally comprises hue, saturation and brightness components;
the chroma key code segment sets the color value of the third pixel equal to the color value of the second pixel when:
the hue component of the first pixel is greater than or equal to a first predefined threshold and the hue component of the first pixel is less than or equal to a second predefined threshold, and
the saturation component of the first pixel is greater than or equal to a third predefined threshold and the saturation component of the first pixel is less than or equal to a fourth predefined threshold, and
the brightness component of the first pixel is greater than or equal to a fifth predefined threshold and the brightness component of the first pixel is less than or equal to a sixth predefined threshold; and
otherwise the chroma key code segment sets the color value of the third pixel equal to the color value of the first pixel.

20. The video presentation system of claim 14, wherein the first buffer has a first dimension and a second dimension and the second buffer has a first dimension and a second dimension, further comprising:
a scaling code segment for resizing the first buffer such that the first dimension of the first buffer is equal to the first dimension of the second buffer and the second dimension of the first buffer is equal to the second dimension of the second buffer.
